(19) United States
(12) Patent Application Publication
(10) Pub. No.: US 2015/0217639 A1
(43) Pub. Date: Aug. 6, 2015

(54) AUTOMOBILES WITH ACCESSORIES

(71) Applicant: Dogsky Booskyee Booskulini, Indianapolis, IN (US)

(72) Inventor: Dogsky Booskyee Booskulini, Indianapolis, IN (US)

(21) Appl. No.: 14/296,710

(22) Filed: Jun. 5, 2014

Related U.S. Application Data
(60) Provisional application No. 61/965,672, filed on Feb. 6, 2014.

(51) Int. Cl. B60K 16/00; B60J 5/04; B60N 2/02; B60R 11/02

(52) U.S. Cl. CPC B60K 16/00; B60R 11/02; B60R 11/0252; B60J 5/0472; B60N 2/02; B60K 2016/003; B60R 2011/0084

(57) ABSTRACT

I have tried to anticipate the next advance in respect to the automobile. In my invention, I want the automobile to become more of a family member and for everyone in the family to enjoy the automobile even more. In a park like setting, every family member would enjoy certain aspects of my invention. The parents could watch a movie on the large DVD screen in the front of the car while the kids can enjoy the rumble seat and the computer monitor, playing video games while sitting in chairs at the rear of the car. I have not seen an automobile in the market like my invention. I believe families will enjoy this automobile. I hope so! This invention is for all automobiles, including passenger automobiles, pick-up trucks and SUV's.

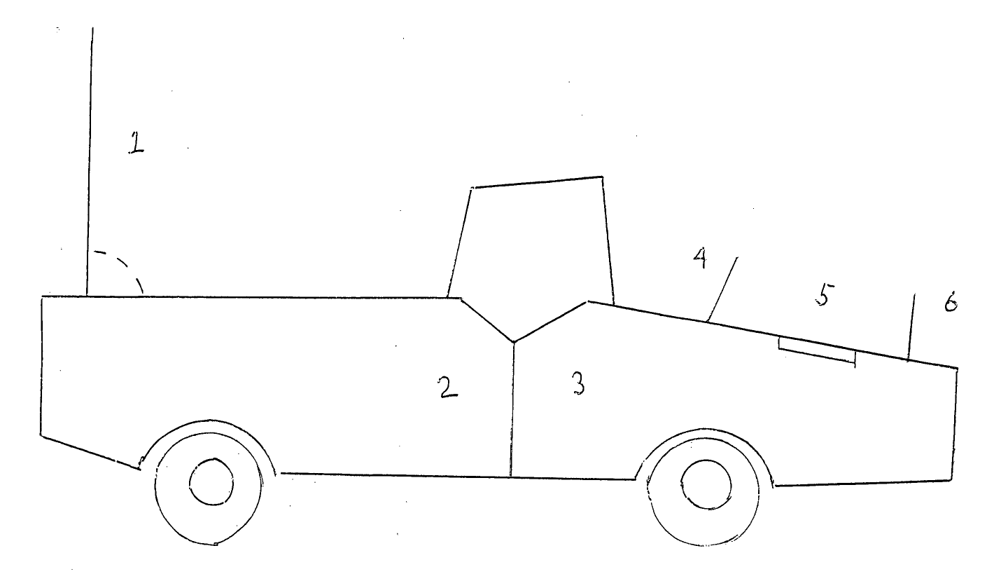

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

I love automobiles. I have been fascinated with the automobile ever since I watched my father take an engine apart, repair it and then put the engine back together.

I have tried to anticipate the next advances in the development of the automobile. In that way, I came up with the idea of having a large DVD T.V., internet screen coming up from the hood section of the automobile. I have also anticipated having solar panels on each side of the trunk for electric and hybrid cars. My invention includes a computer monitor coming up from the rear section of the car so that teenagers and kids can play video games, use the internet and watch movies (maybe in a park setting).

The use of scissor doors, suicide doors and the rumble seat may be already patented; however, I wanted to reveal my complete concept.

### BRIEF SUMMARY OF THE INVENTION

As I discussed earlier, my invention includes a large DVD T.V. and internet screen coming up from the hood using hydraulic and computer technology. This large screen will be lowered and raised by hydraulic and computer technology. Obviously, the car will not be able to start when the screen is up.

Another aspect of my invention will include solar panels on each side of the trunk to recharge the car's batteries on electric and hybrid automobiles. My invention also includes having a computer monitor in the rear of the car, raised and lowered by hydraulic and computer technology. Kids and teenager, I believe, will enjoy this feature.

Other aspects of my invention include a rumble seat, which again I believe kids and teenagers would really enjoy. Also my invention includes scissor doors in front and suicide doors in the rear. All three of these ideas may already be patented; however, I wanted to show my complete concept. I may have to pay for the use of these three ideas.

All that will be needed to raise and lower the large DVD screen on the hood of the car and the lap-top, I-pad at the rear of the car is to push a button.

### BRIEF DESCRIPTION OF THE SEVERAL VIEWS OF THE DRAWING

In the drawing for AUTOMOBILES WITH ACCESSORIES the following reference numbers correspond to the explanation of each claim on the drawing:

1 This shows the 108+ inch large screen for movies, television, internet and games that can be raised and lowered by hydraulic and computer technology.

2 This shows the scissor front doors.

3 This shows the suicide rear doors.

4 This displays the rumble seat.

5 This shows the solar panels located on each side of the trunk for the electric and hybrid automobiles.

6 This shows the 36 inch lap top, computer, and I-pad at the rear of the car for kids and teenagers. It can be raised and lowered by hydraulic and computer technology.

### DETAILED DESCRIPTION OF THE INVENTION

The complete concept of this automobile, I believe, will enhance the family experience with the automobile. My invention includes a large DVD T.V. and interne screen on the hood of the car. (drawing reference #1) This screen will be lowered and raised by hydraulic and computer technology. The car will not be able to start when the screen is in the raised position. I believe families will appreciate this invention at a park like setting. Another aspect of my invention is a computer monitor in the rear of the car, for kids and teenagers, that can be raised and lowered by hydraulic and computer technology. (drawing reference #6)

My invention also includes solar panels on each side of the trunk, so that batteries can be re-charged by the sun for electric and hybrid automobiles. (drawing reference #5) The rumble seat, scissor doors and suicide doors are part of my invention that may already be patented. (drawing reference # 2, #3, and #4) I may have to pay for the use of these three aspects of my invention.

All of the above show my complete concept for “AUTOMOBILES WITH ACCESSORIES”.

1. This shows the 108+ inch large screen for movies, television, internet and games that can be raised and lowered by hydraulic and computer technology.

2. This shows the scissor front doors. This invention may already be patented; however, it is shown to explain the complete concept.

3. This shows the suicide rear doors. This invention may already be patented; however, it is shown to explain the complete concept.

4. This displays the rumble seat. This invention may already be patented; however, it is shown to explain the complete concept.

5. This shows the solar panels located on each side of the trunk for the electric and hybrid automobiles.

6. This shows the 36 inch lap top, computer, and I-pad at the rear of the car for kids and teenagers. It can be raised and lowered by hydraulic and computer technology.
